(19) United States
(12) Patent Application Publication
(10) Pub. No.: US 2017/0338611 A1
(43) Pub. Date: Nov. 23, 2017

(54) METHOD FOR PRODUCING AN ELECTRICALLY CONDUCTIVE CONNECTION BETWEEN A COPPER COMPONENT AND AN ALUMINUM COMPONENT

(71) Applicant: Robert Bosch GmbH, Stuttgart (DE)

(72) Inventors: Andreas Topf, Ballstaedt (DE); Gert Callies, Wrisbergholzen (DE); Jeihad Zeadan, Kelmis (BE); Matthias Roepke, Hildesheim (DE); Nico Weller, Lauffen Am Neckar (DE); Rene Deponte, Sersheim (DE); Sarah Overmeier, Bamberg (DE); Sebastian Stein, Diekholzen (DE)

(21) Appl. No.: 15/534,036

(22) PCT Filed: Dec. 1, 2015
(86) PCT No.: PCT/EP2015/078167

§ 371 Date: Jun. 8, 2017

(30) Foreign Application Priority Data
Dec. 10, 2014 (DE) 10 2014 225 393.4

(51) Int. Cl. H01R 43/02; H02K 15/00; H01R 43/06

(52) U.S. Cl. CPC H01R 43/02; H01R 43/06; H02K 15/0056

(57) ABSTRACT

The invention relates to a method for producing an electrically conductive connection between a copper component 23, 23a and an aluminum component 24 by means of cold metal transfer welding, in which a welding wire is periodically moved back and forth from the material of a component to be welded.

### BACKGROUND OF THE INVENTION

The invention relates to a method for producing an electrically conductive connection between a copper component and an aluminum component.

Electric starter motors are known by way of example from WO 02/16763 A1 and said starter motors are used to start internal combustion engines and are provided with a commutating device so as to transfer and reverse current to an armature that is mounted in such a manner as to be able to rotate in the starter. The commutating device comprises an armature side commutator or collector and multiple carbon brushes that lie on the collector, said carbon brushes in each case being influenced with a force by a brush spring radially onto the peripheral surface of the collector. The collector comprises multiple lamellae that are distributed over the periphery, said lamellae conducting current to armature windings in the case of contact with the brushes. The lamellae are typically embodied from copper, the connection to the armature windings is produced by way of connecting stranded wires that are connected to the lamellae.

### SUMMARY OF THE INVENTION

The object of the invention is to produce a permanent, current-conducting connection between a copper component and an aluminum component of an electric machine.

The method in accordance with the invention is implemented so as to produce an electrically conductive connection between a copper component and an aluminum component. The electrically conductive connection can be used in different electric machines, for example in motors or generators or in electromagnetic relays. By way of example, a connection of this type is produced between copper lamellae of a collector in a commutating device and an aluminum wire that is connected to an armature winding or part of the armature winding. For example, the connection in a generator between an aluminum wire and a copper current rail or the connection between a copper crimp and one or multiple aluminum wires that are encompassed by the copper crimp is also possible. Furthermore, a connection between a copper component and an aluminum component is possible in electric machines that are part of a hybrid system, by way of example in combination with an internal combustion engine. The aluminum-copper connection can be used in the case of cell connectors, connecting pieces, current rail connections, in the case of battery systems and when integrating battery systems by way of current-conducting systems.

In the case of the method in accordance with the invention, the connection between the copper component and the aluminum component is produced by means of cold metal transfer welding (CMT) in which a welding wire is periodically moved in the direction of and away from the basic material of one of the components that is to be welded. The CMT welding method has the advantage that when producing the aluminum-copper connection it is possible to avoid a brittle intermetallic phase. The CMT method is characterized by means of a precise procedure control in the case of a relatively low input of energy into the joining zone between the joining partners aluminum and copper. Accordingly, the temperature—compared with other welding methods—is relatively low. The CMT method provides a permanent, reliable connection between the joining partners aluminum and copper with a high electrical conductivity of the connection.

In the case of the CMT method, the welding wire or supplementary wire periodically moves forward and backward in the direction of the joining site or welding site. During the welding procedure, the welding wire moves in the electric arc for as long as it takes to produce a short circuit and for the electric arc to be interrupted, at which point the welding wire is drawn back. In the burning phase, the electric arc merely introduces heat over a relatively short period of time. After the welding wire has been drawn back, the short circuit is eliminated and the electric arc is regenerated and directed at the joining site. During the backwards movement of the welding wire, the droplet release procedure is supported, which leads to a splash-free welding procedure.

The forward and backward movement of the welding wire occurs with a relatively high frequency of by way of example at least 50 Hz, for example 70 Hz, wherein where appropriate lower or higher frequencies are also possible, by way of example 130 Hz.

The aluminum component is embodied at least predominantly from aluminum, said component therefore comprising an aluminum proportion of at least 50%, advantageously at least 80% or at least 90%. Accordingly, alloys are also possible if the proportion of aluminum in the basic material is at least 50%.

The copper component is likewise at least predominantly embodied from copper so that the copper proportion is at least 50%, preferably at least 80% or at least 90%. In this case, alloys are also possible if the copper proportion is at least 50%.

The welding wire in a preferred embodiment is likewise embodied from aluminum or comprises an aluminum proportion of at least 50%.

The aluminum component is by way of example an aluminum wire that can be provided where appropriate with an insulating layer, by way of example an insulating paint, wherein in the region of the welding site the insulating layer has been advantageously removed. The aluminum wire can be used for a winding, by way of example for an armature winding in an electric machine, wherein the welded connection to the copper is produced in the region of the free ends of the aluminum wire.

The copper component is by way of example a copper wire or a copper current rail. In the case of a commutating device, the copper component is a lamella of the collector that is connected by means of the CMT method to the aluminum wire of the armature winding or an aluminum stranded wire by way of which the electrical connection to the armature winding is produced.

In accordance with a further advantageous embodiment, the copper component is coated at least in the region of the welding site with a tin coating. The tin coating prevents a contact corrosion between the aluminum and the copper after the welding procedure. An intermetallic phase growth that is produced as a result of the effect of temperature is avoided by means of the tin coating.

In accordance with a further expedient embodiment, it is also possible for aluminum components that are arranged in a multi-layered manner to be connected to one another using the CMT method. It is thus by way of example possible to weld two aluminum conductors to one another with the aid of the CMT method. It is possible chronologically prior to or after welding the aluminum components to weld said aluminum components to the copper component using the CMT method.

In accordance with a further expedient embodiment, the joining partners are mechanically connected to one another, by way of example by means of crimping, prior to implementing the CMT method. For example, two aluminum conductors can be held together with the aid of a crimp that is preferably embodied from copper, wherein after the mechanical connection has been produced, the CMT method is implemented so as to weld the crimp to the aluminum conductors. It is consequently expedient for the mechanical connection of two aluminum components to use a copper component that is connected to one or to the two aluminum components using the CMT method.

### BRIEF DESCRIPTION OF THE DRAWINGS

Further advantages and expedient embodiments are evident in the further claims, the description of the figures and the drawings. In the drawings:

FIG. 1 illustrates a starting device for an internal combustion engine in a longitudinal section,

FIG. 2 illustrates in a perspective view two aluminum conductors that are connected using the CMT welding method to a tin-coated commutator lamella that is embodied from copper,

FIG. 3 illustrates schematically a sectional view with the welded connection between two aluminum conductors and a commutator lamella,

FIG. 4 illustrates a commutator lamella in a side view with a bevel in the region of a section that is bent radially outwards and the welded connection to the aluminum conductor connects to said bent section,

FIG. 5 is an illustration corresponding to FIG. 4 however with a rounded transition on the section of the lamella that extends radially outwards,

FIG. 6 illustrates a lamella having a U-shaped recess in the region of the part, said recess being used to connect to the aluminum conductor, wherein the entire lamella is projected in one plane,

FIG. 7 illustrates in a perspective view two aluminum wires in connection with a copper current rail of a generator,

FIG. 8 illustrates the connection in accordance with FIG. 7 in a schematic plan view,

FIG. 9 illustrates in a perspective view two aluminum conductors that are connected with the aid of a copper crimp,

FIG. 10 illustrates a welding tool for the cold metal transfer method.

Identical components in the figures are provided with identical reference numerals.

### DETAILED DESCRIPTION

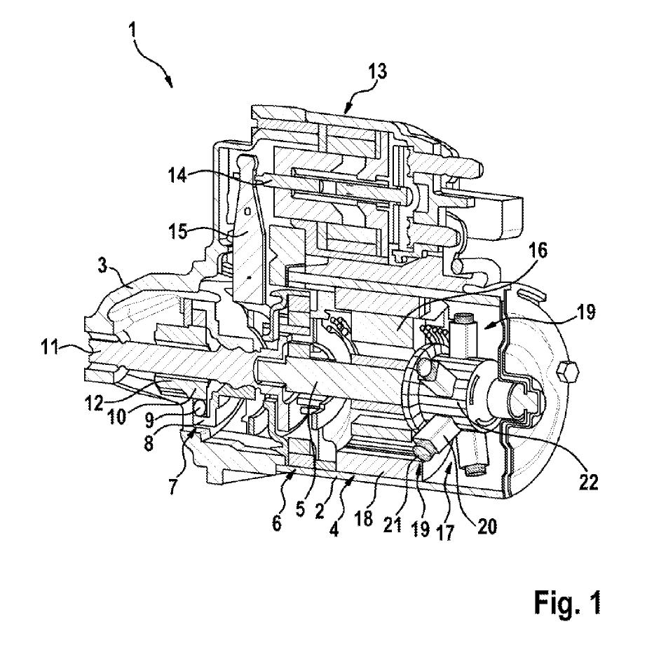

FIG. 1 illustrates a starting device 1 for an internal combustion engine, said starting device receiving an electric starter motor in a housing 2 that comprises a forward-lying bearing plate 3. The motor shaft 5 of the starter motor 4 drives a drive shaft 11 by way of a planetary gear 6, and a carrier 8 of a freewheel device 7 is arranged on said drive shaft and is coupled in an axially-displaceable manner yet in the direction of rotation to the drive shaft 11. The carrier 8 supports itself by way of supporting rollers 9 on a roller bundle 10 that is embodied as a single part with a starter sprocket 12. In the case of an axial feed motion, the starter sprocket 12 moves from a retracted out-of-operation position into an advanced engagement position with the sprocket wheel of an internal combustion engine.

The axial feed motion of the starter sprocket 12 is performed with the aid of an electromagnetic starter relay 13 that comprises an axially-adjustable lifting armature 14 that is coupled to a fork lever. In the case of an axial adjusting movement of the lifting armature 14, the fork lever 15 that is mounted on the housing is pivoted as a result of which the carrier 8 including the starter sprocket 12 is adjusted in the axial direction.

The electric starter motor 4 is embodied as an internal rotor motor and comprises an armature 16 that is connected to the motor shaft 5 in such a manner that said armature cannot rotate with respect to said motor shaft and said armature includes armature coils or armature windings that can be electrically excited. The armature windings of the armature 16 are energized by way of a commutating device 17. The electromagnetic field that is generated by the electric armature windings interacts with the magnetic field of permanent magnets 18 that are arranged on the inner side of the stator that surrounds the armature.

The commutating device 17 comprises multiple spring-brush units 19 that comprise in each case on the housing side a carbon brush 20 and a brush spring 21, and also an armature-side collector 22 that comprises lamellae that are distributed over the periphery, said lamellae being electrically separated from one another and connected to the armature windings. The carbon brushes 20 are influenced with a force by the brush springs 21 radially against the peripheral surface of the collector 22. Carbon brushes 20 and brush springs 21 are expediently received in brush holders that are fixedly connected to the housing of the starter motor. Altogether six spring-brush units 19 are provided distributed over the periphery in a uniform manner. Where appropriate, it is also possible to arrange only four spring-brush units 19 distributed over the periphery.

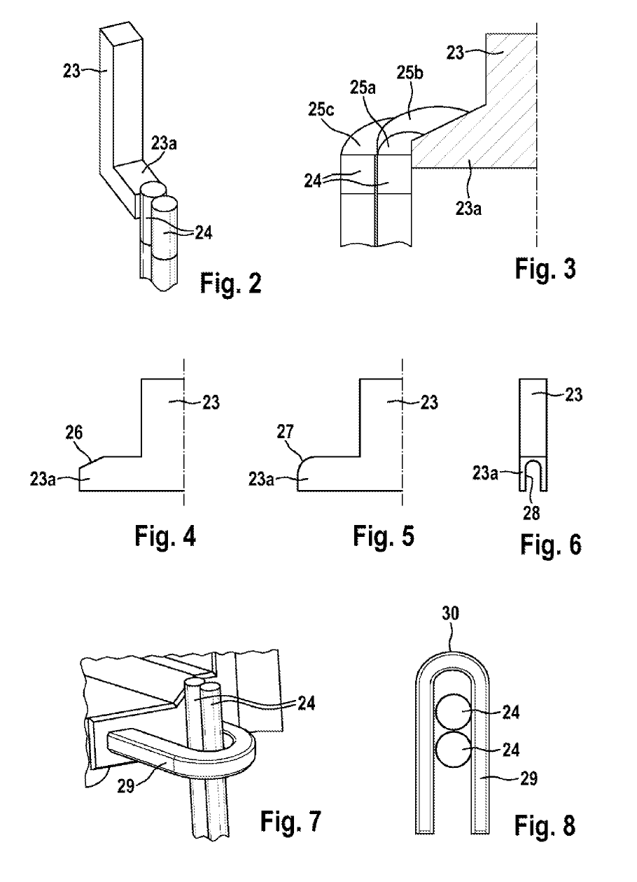

FIG. 2 illustrates the connection between a lamella 23 and two aluminum wires 24 that are associated with in each case one armature winding. The lamella 23 is embodied from copper and comprises a section that extends in the axial direction of the motor longitudinal axis and the carbon brushes lie on the outer side of said section. A radial section 23a is located as one piece with the axial section on an end face and the connection to the aluminum wires 24 is produced with the aid of the cold metal transfer welding method (CMT) on the radially outer-lying end face of said section.

FIG. 3 illustrates the various phases during the CMT welding method. The additional material that originates from a welding wire initially connects the end face of the aluminum wire 24, which is placed closest on the end face of the radial section 23a of the lamella 23, to the section 23a. Further additional material 25b is subsequently accumulated on the first additional material 25a that is connected on the side of the lamella 23 to the beveled end face of the section 23a of the lamella. Finally, further additional material 25c is applied between the end face of the second aluminum wire 24 that lies further away and the two first accumulations of additional material 25a and 25b.

As is furthermore evident in FIGS. 2 and 3, the aluminum wire 24 is provided with an insulating coating, in particular an insulating paint, wherein merely the end sections that are connected by means of the CMT welding method to the lamellae are free from insulating coating.

FIGS. 4 to 6 illustrate schematically various geometric embodiments of the radial section 23a of a lamella 23. The radial section 23a of the lamella 23 forms a lamellae lug. In accordance with FIG. 4 the radial section 23a comprises a bevel 26 between the radially outer-lying end face and the inner-lying side surface that extends adjacent to the axial section of the lamella. In FIG. 5, the transition between the radially outer-lying end face of the radial section 23a and the side surface that is facing the axial section is embodied as rounded. In FIG. 6, a U-shaped recess 28 is introduced into the radial section 23a and the end of an aluminum wire can be inserted into said recess.

FIGS. 7 and 8 illustrate a further exemplary embodiment for a connection between a copper current rail 29 in a generator and two aluminum wires 24. The copper current rail 29 is coated with a tin coating 30 (FIG. 8). The two aluminum wires 24 and the copper current rail 29 are connected to one another using the CMT welding method.

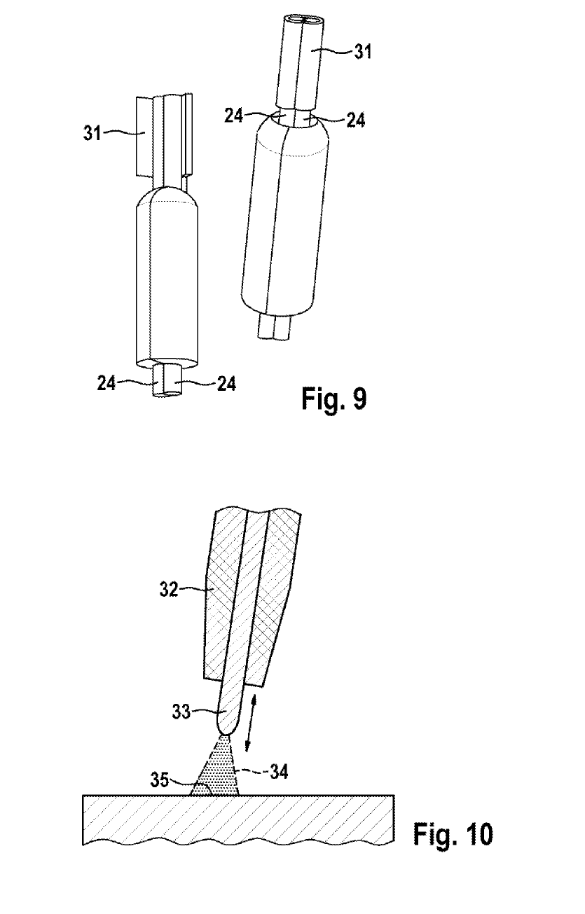

FIG. 9 illustrates two illustrations of the connection of two aluminum wires 24 that extend parallel to one another with the aid of a copper crimp 31. The crimp 31 is initially placed mechanically around the end sections of the two aluminum wires 24 that lie parallel to one another and are joined together so that a mechanical connection is produced between the crimp 31 and the two aluminum wires 24. A welded connection is subsequently produced with the aid of the CMT method in which the copper crimp 31 and the aluminum wires 24 are welded to one another.

FIG. 10 illustrates a welding tool 32 that is used for the CMT welding method. A welding wire 33 is periodically moved in the welding tool 32 in the direction of the welding site 35 or moved away from the welding site 35 as indicated by the double arrow. The frequency of the movement of the welding wire 33 is by way of example 70 Hz.

The welding tool 32 generates an electric arc 34 that makes contact with the welding site 35 on the workpiece. As the welding wire 33 approaches the welding site 35, said wire being embodied by way of example from aluminum, a short circuit is produced and as a result of which the electric arc 34 is interrupted. During the subsequent rearwards movement of the welding wire 33 a droplet release procedure occurs, the short circuit is simultaneously eliminated and the electric arc 34 is regenerated. Owing to this periodically-repeating procedure, the introduction of heat into the work piece is relatively low.

1. A method for producing an electrically conductive connection between a copper component and an aluminum component each having a basic material, the method comprising using a cold metal transfer welding (CMT) process in which a welding wire (33) is periodically moved in a direction of or away from the basic material of one of the components (23, 24) that are to be welded.

2. The method as claimed in claim 1, characterized in that the copper component (23) is coated at least in the region of a welding site (35) with a tin coating (30).

3. The method as claimed in claim 1, characterized in that the basic material of the aluminum component (24) is at least predominantly aluminum.

4. The method as claimed in claim 1, characterized in that the basic material of the copper component (23) is at least predominantly copper.

5. The method as claimed in claim 1, characterized in that an aluminum wire (24) is used as the aluminum component.

6. The method as claimed in claim 1, characterized in that a copper wire, a copper lamella (23) or a copper current rail (29) is used as the copper component.

7. The method as claimed in claim 1, characterized in that multi-layered aluminum components (24) are connected to one another and are connected to the copper component (23) in each case using the cold metal transfer welding (CMT) process.

8. The method as claimed in claim 7, characterized in that the cold metal transfer welding process of the aluminum components (24) is performed chronologically prior to or after the welding to the copper component (23).

9. The method as claimed in claim 1, further comprising mechanically connecting the components (23, 24) that are to be welded, prior to performing the cold metal transfer welding (CMT) procedure.

10. The method as claimed in claim 1, characterized in that the welding wire (33) is embodied from aluminum.

11. A method for manufacturing an electric machine, having an electrically conductive connection between a copper component and an aluminum component, the method comprising producing the electrically conductive connection using the method claimed in claim 1.

12. The method as claimed in claim 11, characterized in that the connection between a collector (22) having copper lamellae in a commutating device (17) and an armature winding (24) is embodied from aluminum.

13. The method as claimed in claim 12, characterized in that copper lamellae (23) of the collector (22) comprise lamellae lugs that protrude radially outwards and said lamellae lugs are welded to the aluminum wire (24) of the armature winding.

14. The method as claimed in claim 13, characterized in that the lamellae lugs comprise a bevel on a radially outer-lying end face.

15. The method as claimed in claim 13, characterized in that the lamellae lugs are rounded on a radially outer-lying end face.

16. The method as claimed in claim 13, characterized in that the lamellae lugs comprise a U-shaped recess on a radially outer-lying end face for receiving an aluminum wire (24).

17. A method for producing an electromagnetic relay, having an electrically conductive connection between a collector (22) having copper lamellae in a commutating device (17) and an armature winding that is embodied from aluminum, the method comprising producing the electrically conductive connection using the method claimed in claim 1.

18. (canceled)

19. The method as claimed in claim 1, wherein the copper component and the aluminum component are, respectively, a collector (22) having copper lamellae (23) in a commutating device (17) of an electric machine and an armature winding that is embodied from aluminum.

20. The method as claimed in claim 9, characterized in that the components (23, 24) are mechanically connected to one another by crimping.
